(19) United States
(12) Patent Application Publication
(10) Pub. No.: US 2026/0109067 A1
(43) Pub. Date: Apr. 23, 2026

(54) SLOTTING MECHANISM AND BATTERY PRODUCTION DEVICE

(71) Applicant: Wuxi Lead Intelligent Equipment Co., Ltd., Jiangsu (CN)

(72) Inventors: Xingyang Zhang, Jiangsu (CN); Benchang Dong, Jiansu (CN); Zhen Liu, Jiangsu (CN)

(73) Assignee: Wuxi Lead Intelligent Equipment Co., Ltd., Jiangsu (CN)

(21) Appl. No.: 19/230,992

(22) Filed: Jun. 6, 2025

Related U.S. Application Data
(63) Continuation of application No. PCT/CN2024/132693, filed on Nov. 18, 2024.

(30) Foreign Application Priority Data
Jun. 24, 2024 (CN) 202421463504.2

(51) Int. Cl. B26D 3/12; B26D 7/18; B26D 7/26; H01M 10/04; H01M 50/536

(52) U.S. Cl. CPC B26D 3/12; B26D 7/1863; B26D 7/2614; H01M 10/0404; H01M 50/536

(57) ABSTRACT

The present disclosure provides a slotting mechanism and a battery production device. The slotting mechanism includes: a base; and a slotting assembly movably provided on the base along a first direction to approach or move away from a cell, and to provide slots positioned radially on an end face of the cell.

### CROSS-REFERENCE TO RELATED APPLICATIONS

The present disclosure is a National Stage of International Application No. PCT/CN2024/132693, filed on Nov. 18, 2024, which claims priority to a Chinese patent application No. 202421463504.2 filed with the CNIPA on Jun. 24, 2024 and entitled “SLOTTING MECHANISM AND BATTERY PRODUCTION DEVICE”, both of which are hereby incorporated by reference in their entireties.

### TECHNICAL FIELD

The present disclosure relates to the technical field of a battery production devices, and particularly to a slotting mechanism and a battery production device.

### BACKGROUND

In the manufacturing process of cylindrical batteries, it is typically necessary to flatten the tab at the end of the cell to ensure a smooth end face of the cell before welding the collector disk to the cell. However, during the flattening process, metal contaminants are produced and can remain on the end face of the cell, thereby impacting the welding quality and, consequently, the overall quality of the cell.

### SUMMARY

Based on the above, it is necessary to provide a new technical solution of a slotting mechanism and a battery production device for the above problem, which can at least solve the problem that in the prior art, metallic foreign matter residues are easily produced when the cell is flattened.

According to a first aspect of the present disclosure, a slotting mechanism is proposed, which comprises: a base; and a slotting assembly movably provided on the base along a first direction to approach or move away from a cell, and configured to radially create a slot on an end face of the cell.

Optionally, the slotting assembly comprises: a mounting disk movably provided on the base along the first direction; a slotting cutter movably provided on the mounting disk along a radial direction of the cell; and a first driving member connected to the slotting cutter and configured to drive the slotting cutter.

Optionally, there is provided a plurality of slotting cutters arranged circumferentially around the mounting disk.

Optionally, the slotting cutter comprises: a connecting block connected to the mounting disk; and a cutter head, one end of which connected to the connecting block and the other end forming a cutting edge, a distance between the cutter head and a side of the mounting disk facing the cutter head gradually increasing in a direction from periphery towards center of the mounting disk.

Optionally, the cutting edge extends along a straight line, and is provided with a rounded termination at each of the two ends thereof.

Optionally, the slotting assembly further comprises: a speed regulating valve provided on the first driving member for regulating a speed of the slotting cutter.

Optionally, further comprising: a pressure regulating assembly connected to the slotting assembly for regulating a pressure between the slotting assembly and the end face of the cell.

Optionally, by further comprising: a dust collection assembly provided on the base, defining a dust collection chamber and an inlet in communication with the dust collection chamber, the inlet being capable of generating negative pressure to draw in foreign matter produced during slotting into the dust collection chamber.

Optionally, the slotting assembly is switchable between a first state and a second state, when in the first state, the slotting assembly is in contact with the end face of the cell and radially creates a slot on the end face of the cell, and at least part of an orthogonal projection of the slotting assembly onto a horizontal plane coincides with an orthogonal projection of the inlet onto the horizontal plane; when in the second state, the slotting assembly is spaced apart from the cell, and the orthogonal projection of the slotting assembly onto the horizontal plane is staggered with the orthogonal projection of the inlet onto the horizontal plane.

Optionally, the dust collection assembly comprises: a dust collection box provided with the dust collection chamber as well as the inlet and an outlet, the inlet being located below the slotting assembly for collecting the foreign matter; and a vacuuming member being in communication with the outlet for vacuuming the dust collection chamber.

Optionally, the inlet and the outlet are spaced apart in a second direction perpendicular to the first direction.

Optionally, the dust collection box and the inlet extend along the second direction respectively.

Optionally, the dust collection chamber comprises a first channel, a second channel, and a third channel which are sequentially connected, the first channel and the second channel extending along a third direction respectively, the third channel extending along the second direction, the third direction being perpendicular to the first direction and the second direction respectively, one end of the first channel away from the second channel forming the inlet, a cross-sectional area of the first channel gradually decreasing in a direction from the first channel towards the second channel, and one end of the third channel away from the second channel forming an outlet.

Optionally, the dust collection assembly further comprises: a connection member provided on a side of the dust collection box away from the cell and provided with a dust collection channel inside extending along the first direction, one end of the dust collection channel being in communication with the outlet, and the other end of the dust collection channel being in communication with the vacuuming member.

Optionally, the slotting mechanism further comprises: a positioning assembly provided on the slotting assembly and configured to position a jig of the cell.

Optionally, the positioning assembly comprises: at least two positioning pins configured to cooperate with positioning holes on the jig to position the jig.

Optionally, the slotting mechanism further comprises: a guiding member provided on the base and extending along the first direction, to which the slotting assembly being connected and can move along; and a second driving member provided on the base and connected to the slotting assembly to drive it to move along the first direction.

According to a second aspect of the present disclosure, a battery production device is provided, which comprises the slotting mechanism according to any one of the above embodiments.

Optionally, the battery production device is provided with a slotting station where the slotting mechanism is provided, and further comprises: a jig configured to hold the cell; and a conveying mechanism configured to convey the jig to the slotting station, a plurality of slotting mechanisms provided on both sides of the conveying mechanism.

According to the slotting mechanism of the present disclosure, by providing the slotting assembly to approach the cell along the first direction and radially slotting the end face of the cell, it is possible to facilitate the protruding structure of the collector plate to extend into the slot on the end face of the cell before welding. The processed slot may accommodate the protruding structure of the collector plate, such that the collector plate may be welded directly with the end face of the cell without requiring flattening. In addition, the metallic foreign matters produced from slotting may naturally fall off, preventing residue on the end face of the cell and thus improving the welding quality.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings incorporated in and constituting a part of the specification illustrate embodiments of present disclosure and together with the description thereof, serve to explain the principles of the disclosure.

FIG. 1 is a front view of a battery production device according to an embodiment of the present disclosure;

FIG. 2 is a top view of a battery production device according to an embodiment of the present disclosure;

FIG. 3 is a perspective view of a slotting mechanism and a jig in a battery production device according to an embodiment of the present disclosure;

FIG. 4 is a perspective view of a slotting mechanism according to an embodiment of the present disclosure;

FIG. 5 is a side view of a slotting mechanism according to an embodiment of the present disclosure;

FIG. 6 is a perspective view of a slotting cutter in a slotting mechanism according to an embodiment of the present disclosure;

FIG. 7 is an enlarged view of the area circled as A in FIG. 6;

FIG. 8 is a side view of a slotting cutter in a slotting mechanism according to an embodiment of the present disclosure;

FIG. 9 is a perspective view of a dust collection box and a connection member in a slotting mechanism according to an embodiment of the present disclosure;

FIG. 10 is a top view of a dust collection box and a connection member in a slotting mechanism according to an embodiment of the present disclosure;

FIG. 11 is a sectional view along B-B line of FIG. 10.

### DESCRIPTION OF REFERENCE SIGNS

100, slotting mechanism;
10, base;
20, slotting assembly; 21, mounting disk; 22, slotting cutter; 221, connecting block; 222, cutter head; 223, cutting edge; 224, rounded end; 23, first driving member; 24, speed regulating valve;
30, dust collection assembly; 31, dust collection box; 311, dust collection chamber; 312, inlet; 313, outlet; 314, first channel; 315, second channel; 316, third channel; 32, connection member; 321, dust collection channel;
40, pressure regulating mechanism;
51, positioning pin;
60, guiding member;
70, second driving member;
200, jig; 201, positioning hole;
400, cell;
a, slotting station.

### DETAILED DESCRIPTION

Various exemplary embodiments of the present disclosure will now be described in detail with reference to the accompanying drawings. It is to be noted that unless otherwise specifically stated, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, they shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

The slotting mechanism 100 according to embodiments of the present disclosure is first specifically described below in connection with the accompanying drawings.

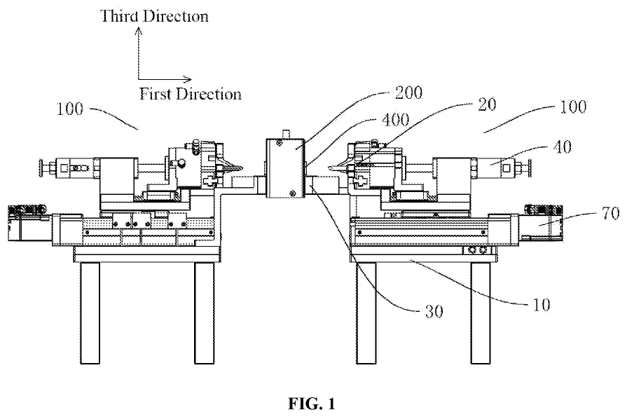

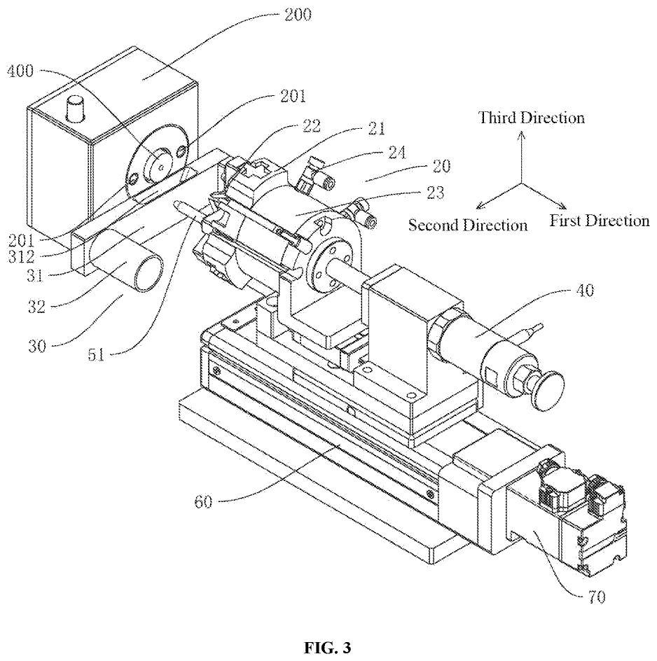

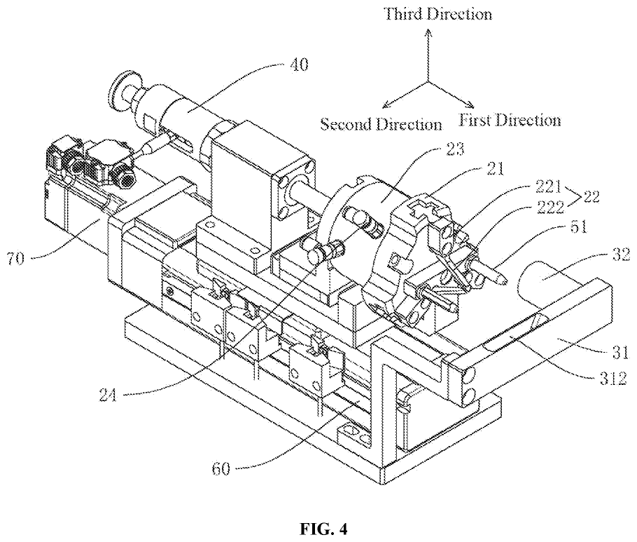

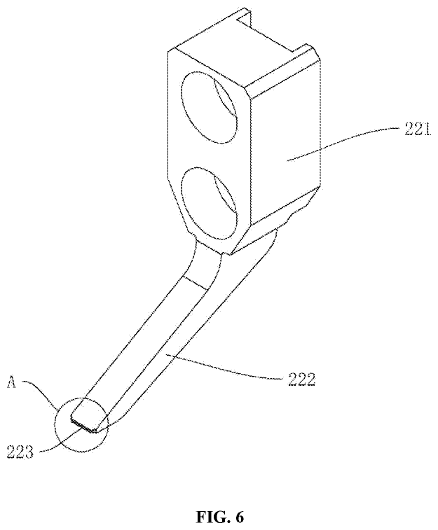

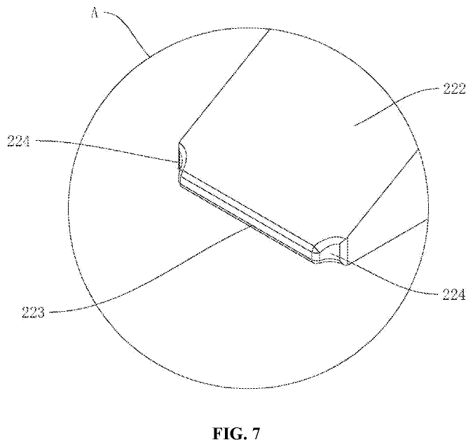

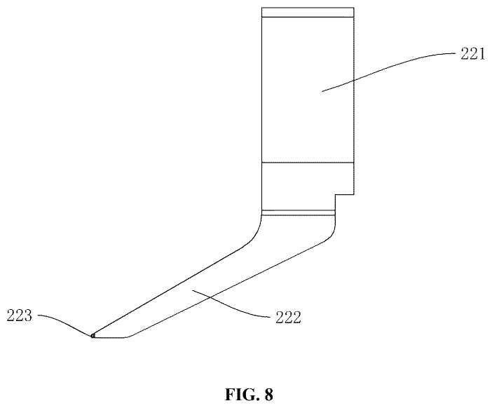

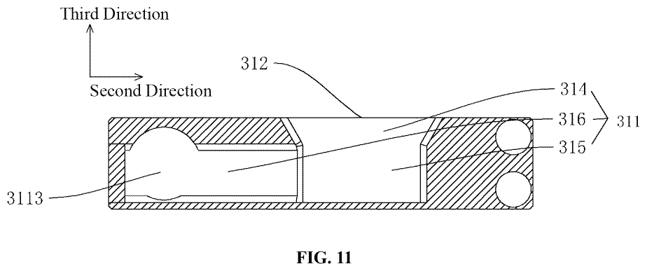

As shown in FIGS. 1 to 11, the slotting mechanism 100 includes: a base 10, a slotting assembly 20 and a dust collection assembly 30.

Specifically, a slotting assembly 20 is movably provided on the base 10 along a first direction to approach or move away from a cell 400, and is configured to radially create a slot on an end face of the cell 400.

In other words, the slotting mechanism 100 according to the embodiment of the present disclosure mainly consists of the base 10, the slotting assembly 20 and the dust collection assembly 30, and the slotting assembly 20 may be mounted on the base 10.

The slotting assembly 20 may approach or move away from the cell 400 along the first direction, and create a slot on an end face of the cell 400. The cell 400 may be fixed in the jig 200 to prevent changes in its position in the process of slotting.

It should be noted that the cell 400 is mainly formed by winding a pole piece and a diaphragm, and the uncoated part of the two ends of the pole piece in the width direction thereof may be formed as a tab. In the conventional technology, the tab on the end of the cell 400 needs to be flattened and then welded with a collector plate, which is easy to produce metallic foreign matter residues.

The slotting assembly 20 of the present embodiment may radially create a slot on the end face of the cell 400. The method of slotting includes but is not limited to cutting, rotating, and impacting, to form slot(s) on the tab structure at the end of the cell 400 that extends in the radial direction of the cell 400. The number of slots may be one or a plurality, which is not limited herein. The collector plate may be provided with protruding structures, which may be inserted into slots on the end face of the cell 400, allowing for direct welding between the collector plate and the cell 400, thereby eliminating the flattening process.

During the slotting process, the slotting assembly 20 produces metallic foreign matters, which can fall off by gravity without remaining on the end face of the cell 400, thus contributing to improved welding quality.

Therefore, according to the slotting mechanism 100 of the embodiments of the present disclosure, by providing the slotting assembly 20 to approach the cell 400 along the first direction and radially slotting the end face of the cell 400, it is possible to facilitate the protruding structures of the collector plate to extend into the slot on the end face of the cell 400 before welding. The processed slot may accommodate the protruding structure of the collector plate, such that the collector plate may be welded directly with the end face of the cell 400 without requiring flattening. In addition, the metallic foreign matters produced from slotting may naturally fall off, preventing residue on the end face of the cell 400 and thus improving the welding quality.

In some specific implementations of the present disclosure, the slotting assembly 20 includes a mounting disk 21, a slotting cutter 22, and a first driving member 23. The mounting disk 21 is movably mounted on the base 10 along the first direction. The slotting cutter 22 is movably mounted on the mounting disk 21 along the radial direction of the cell 400. The first driving member 23 is connected to the slotting cutter 22 and drives the slotting cutter 22.

In other words, the slotting assembly 20 may mainly consist of the mounting disk 21, the slotting cutter 22, and the first driving member 23. The mounting disk 21 may be connected to the base 10 and be movable relative to the base 10 along the first direction. The slotting cutter 22 may be connected to the mounting disk 21, and may move in the radial direction of the mounting disk 21 under the drive of the first driving member 23.

During slotting, the mounting disk 21 may be coaxial with the cell 400. When the slotting cutter 22 moves in the radial direction of the mounting disk 21, it can create a slot on the end face of the cell 400. It should be noted that the slotting cutter 22 may perform slotting from the inside out or from the outside in, which is not limited herein.

Optionally, the first driving member 23 may include but is not limited to a claw cylinder or electric cylinder.

According to some optional embodiments of the present disclosure, a plurality of slotting cutters 22 are arranged circumferentially around the mounting disk 21, enabling the slotting mechanism 100 to create a plurality of radial slots on the end face of the cell 400.

It should be noted that the number of slots on the end face of the cell 400 can be determined based on the specific structure of the collector plate, and then the slotting cutter 22 are added circumferentially on the mounting disk 21.

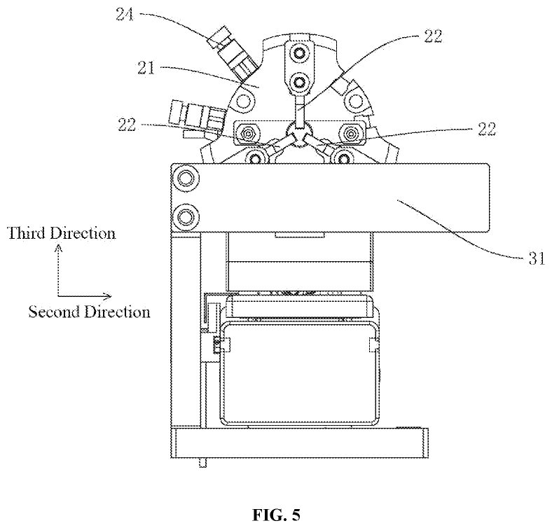

As shown in FIG. 5, three slotting cutters 22 may be provided circumferentially on the mounting disk 21, and may be centrally symmetrically distributed.

According to other embodiments of the present disclosure, the slotting cutter 22 includes a connecting block 221 and a cutter head 222. The connecting block 221 is connected to the mounting disk 21. One end of the cutter head 222 is connected to the connecting block 221, and the other end forms a cutting edge 223. A distance between the cutter head 222 and a side of the mounting disk 21 facing the cutter head 222 gradually increases in a direction from periphery towards center of the mounting disk 21.

Specifically, the slotting cutter 22 mainly consists of the connecting block 221 and the cutter head 222. The connecting block 221 is movably provided on the mounting disk 21 along the radial direction of the mounting disk 21. One end of the connecting block 221 close to the axis of the mounting disk 21 may be connected to one end of the cutter head 222, and the other end of the cutter head 222 may tilt towards the axis of the mounting disk 21 and move away from the side of the mounting disk 21. In other words, the cutter head 222 and the connecting block 221 may form an angle therebetween, which may be an obtuse angle, thereby facilitating the uniformity of force distribution on the slotting cutter 22 and increasing the lifespan of the slotting cutter 22.

Additionally, the end of the slotting cutter 22 away from the connecting block 221 may be provided with the cutting edge 223. When the slotting cutter 22 is moved along the radial direction of the mounting disk 21, the cutting edge 223 may cut the end face of the cell 400 along the radial direction of the cell 400.

In some specific implementations of the present disclosure, the cutting edge 223 extends along a straight line, and is provided with a rounded termination 224 at each of the two ends thereof. Thus, it is possible to make the slots being created on the end face of the cell 400 more regular, preventing the edges of the slot openings from being too sharp which will affect the flattening process of the cell 400 and thus affect the quality of the cell 400.

According to other embodiments of the present disclosure, the slotting assembly 20 further includes a speed regulating valve 24, which is provided on the first driving member 23 for regulating a speed of the slotting cutter 22. By providing the speed regulating valve 24, it is possible to control the slotting force and speed, catering to different slotting requirements.

In some specific implementations of the present disclosure, the slotting mechanism 100 further includes a pressure regulating assembly, which is connected to the slotting assembly 20 for regulating a pressure between the slotting assembly 20 and the end face of the cell 400. Before slotting, it is possible to pre-regulate the pressure regulating assembly, so as to ensure the consistency of the slotting force for each operation and to contribute to improving the quality of slotting.

Optionally, the pressure regulating mechanism 40 may be connected to the slotting assembly 20 through a guiding rod.

According to some optional embodiments of the present disclosure, the slotting mechanism 100 may further include a positioning assembly, which is provided on the slotting assembly 20 and configured to position the jig 200 of the cell 400. Therefore, the positioning assembly may be moved together with the slotting assembly 20 along the first direction. In the process of the slotting assembly 20 approaching the jig 200 which holds the cell 400, the positioning assembly also approaches the cell 400 and completes the positioning of the jig 200, contributing to improving the positioning accuracy; for example, it can ensure the positioning accuracy within 0.2 mm.

According to an embodiment of the present disclosure, the dust collection assembly 30 is provided on the base 10 and defines a dust collection chamber 311 and an inlet 312 in communication with the dust collection chamber 311. The inlet 312 is capable of generating negative pressure to draw in foreign matter produced during slotting into the dust collection chamber 311.

Specifically, the dust collection assembly 30 may be mounted on the base 10. The slotting assembly 20 may produce metallic foreign matters in the process of slotting the end face of the cell 400. Due to the negative pressure at the inlet 312, the metallic foreign matters produced by slotting can be drawn into the dust collection chamber 311 through the inlet 312 and then collectively collected and processed by the dust collection chamber 311.

In the present embodiment, the slotting mechanism 100 is provided with a dust collection assembly 30 therein, which may utilize negative pressure to draw in the metallic foreign matters produced by cutting during slotting to remove dust, avoiding impacts on the quality of the cell 400.

According to some optional embodiments of the present disclosure, the slotting assembly 20 is switchable between a first state and a second state.

The slotting assembly 20, when in the first state, is in contact with the end face of the cell 400 and radially creates a slot on the end face of the cell 400, and at least part of an orthogonal projection of the slotting assembly 20 onto a horizontal plane coincides with an orthogonal projection of the inlet 312 onto the horizontal plane. The slotting assembly 20, when in the second state, is spaced apart from the cell 400, and the orthogonal projection of the slotting assembly 20 onto the horizontal plane is staggered with the orthogonal projection of the inlet 312 onto the horizontal plane.

Specifically, the first state can be a slotting state, and the second state can be a standby state. The inlet 312 can be located below the end face of the cell 400 to receive the metallic foreign matters produced by slotting.

When the slotting assembly 20 is in the first state, the slotting cutter 22 may act on the end face of the cell 400, and then the first driving member 23 drives the slotting cutter 22 to move along the radial direction of the cell 400, so as to radially create a slot on the end face of the cell 400. A horizontal plane may be defined as a projection plane; the projection of the cutting edge 223 of the slotting cutter 22 onto this horizontal plane may coincide with the projection of the inlet 312 onto the same plane, meaning that the inlet 312 may be directly below the cutting edge 223, such that the metallic foreign matters produced by slotting may naturally fall into the inlet 312, thereby facilitating the drawing in and collection of the metallic foreign matters.

When the slotting assembly 20 is in the second state, the slotting cutter 22 is spaced apart from the end face of the cell 400. Since the dust collection box 31 is fixed on the base 10, the inlet 312 remains below the end of the cell 400, and thus the slotting cutter 22 and the inlet 312 are spaced apart in the first direction.

According to an embodiment of the present disclosure, the dust collection assembly 30 includes a dust collection box 31 and a vacuuming member. The dust collection box 31 is provided with the dust collection chamber 311 which is provided with the inlet 312 and an outlet 313. The inlet 312 is located below the slotting assembly 20 for collecting the foreign matter. The vacuuming member is in communication with the outlet 313 for vacuuming the dust collection chamber 311.

Specifically, the inlet 312 of the dust collection box 31 may be located below the slotting assembly 20. When the slotting assembly 20 performs slotting, the metallic foreign matter may fall into the dust collection chamber 311 through the inlet 312 due to gravity, which is beneficial for improving dust collection efficiency. By providing the vacuuming member to be in communication with the outlet 313 through the outlet 313, it is possible to create negative pressure inside the dust collection chamber 311 as well as at the inlet 312, thus drawing in the metallic foreign matters.

According to other embodiments of the present disclosure, the inlet 312 and the outlet 313 are spaced apart in a second direction which is perpendicular to the first direction.

Specifically, when performing slotting, the axis of the cell 400 may extend along the first direction, and the slotting assembly 20 needs to move along the first direction; therefore, space must be reserved along the axial direction of the cell 400 to accommodate the movement of the slotting assembly 20. Since the first direction is perpendicular to the second direction, the second direction may be the radial direction of the cell 400.

To ensure dust collection efficiency, the inlet 312 may be provided below the end of the cell 400. Thus, by providing that the inlet 312 and the outlet 313 are spaced apart in the second direction, it is possible to arrange the connection structure between the outlet 313 and the vacuuming member on the side of the slotting assembly 20, thereby facilitating movement of the slotting assembly 20 along the first direction.

In some specific implementations of the present disclosure, the dust collection box 31 and the inlet 312 both extend along the second direction, meaning that the dust collection box 31 can extend along the radial direction of the cell 400 to increase the space of the dust collection chamber 311. The inlet 312 extends along the radial direction of the cell 400, and thus enables the metallic foreign matters produced during radially slotting to fall into the inlet 312, thereby enhancing dust collection efficiency.

According to some optional embodiments of the present disclosure, the dust collection chamber 311 includes a first channel 314, a second channel 315, and a third channel 316 which are sequentially connected. The first channel 314 and the second channel 315 extend along a third direction respectively, while the third channel 316 extends along the second direction. The third direction is perpendicular to the first direction and the second direction respectively. One end of the first channel 314 away from the second channel 315 forms the inlet 312, with a cross-sectional area of the first channel 314 gradually decreases in a direction from the first channel 314 towards the second channel 315, and one end of the third channel 316 away from the second channel 315 forms the outlet 313.

In other words, as shown in FIG. 11, the dust collection chamber 311 may mainly consist of the first channel 314, the second channel 315, and the third channel 316. Optionally, the first direction and the second direction are horizontal directions perpendicular to each other, and the third direction is the vertical direction.

Both the first channel 314 and the second channel 315 extend vertically, whereas the third channel 316 extends horizontally. The top end of the first channel 314 is open to form the inlet 312. The opening may be generally rectangular. The bottom end of the first channel 314 may be connected to the top end of the second channel 315. In the direction from top to bottom, the cross-sectional area of the first channel 314 gradually decreases to form an inclined inner wall surface for guiding the metallic foreign matters to fall into the second passage 315, and the inclined inner wall surface may enhance the dust collecting effect. One end of the third channel 316 in the horizontal direction may be connected to the second channel 315, and the end of the third channel 316 away from the second channel 315 may form the outlet 313.

Consequently, the first channel 314, the second channel 315, and the third channel 316 together form an L-shaped dust collection chamber 311, which can effectively collect and contain the metallic foreign matters, minimizing dispersion of the metal foreign matters in the chamber, thereby preventing the foreign matters from becoming airborne, while also facilitating the cleaning of the dust collection chamber 311.

According to other embodiments of the present disclosure, the dust collection assembly 30 further includes a connection member 32 provided on a side of the dust collection box 31 away from the cell 400 and provided with a dust collection channel 321 inside extending along the first direction, one end of the dust collection channel 321 being in communication with the outlet 313, and the other end of the dust collection channel 321 being in communication with the vacuuming member.

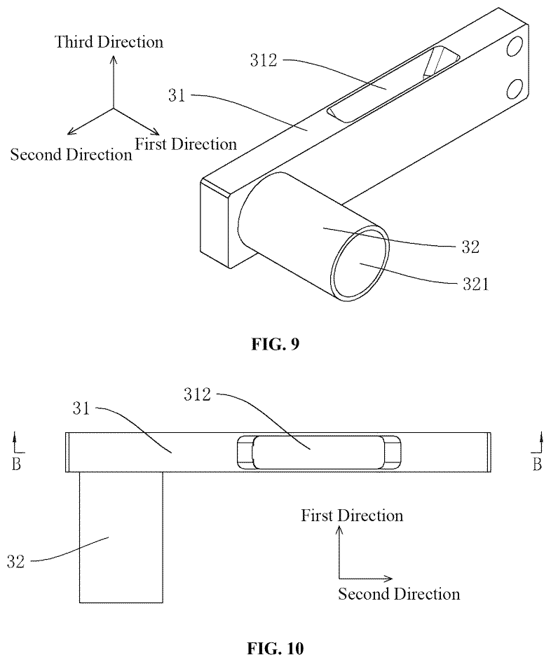

As shown in FIGS. 9 to 11, the dust collection box 31 is provided with the connection member 32 at the outlet 313. Optionally, the connection member 32 and the dust collection box 31 can be an integral unit. The dust collection channel 321 within the connection member 32 may extend towards the side away from the cell 400 along the first direction, and one end of the dust collection channel 321 away from the dust collection box 31 may be in communication with the vacuuming member via a pipe.

In the present embodiment, by providing the connection member 32 on the dust collection box 31, it is possible to facilitate the communication of the dust collection box 31 with the vacuuming member through the pipe, and the pipe may be sleeved onto the outer surface of the connection member 32.

Optionally, the connection member 32 may be cylindrical.

According to other embodiments of the present disclosure, the positioning assembly includes at least two positioning pins 51 configured to cooperate with positioning holes 201 on the jig 200 to position the jig 200.

Specifically, the jig 200 may be provided with a plurality of positioning holes 201, with the axes of the positioning holes 201 extending along the first direction. The number of the positioning holes 201 may be the same as that of positioning pins 51 in the positioning assembly, and the plurality of positioning holes 201 may be in one-to-one correspondence with the plurality of positioning pins 51e.

As the slotting assembly 20 approaches the jig 200 along the first direction, the plurality of positioning pins 51 may be inserted into the positioning holes 201 to complete the positioning of the jig 200. The cell 400 may be clamped by the jig 200, so as to use the positioning pins 51 to position the cell 400, which is beneficial for improving the slotting accuracy.

In some specific implementations of the present disclosure, the slotting mechanism 100 further includes a guiding member 60 and a second driving member 70. The guiding member 60 is provided on the base 10 and extends along the first direction, while the slotting assembly 20 is connected to it and can move along it. The second driving member 70, also provided on the base 10, connects to the slotting assembly 20 to drive it to move along the first direction, ensuring each cell 400 to have a predetermined slotting depth.

Specifically, the base 10 is provided with a guiding member 60 extending along the first direction. Optionally, the guiding member 60 may be a linear guide rail, and the slotting assembly 20 may be connected to a slider. The second driving member 70 may be connected to the slider and drive it to slide along the linear guide rail. The second driving member 70 may include but is not limited to an electric cylinder.

Additionally, the present embodiment provides a battery production device, which includes the slotting mechanism 100 according to any one of the above embodiments. Since the slotting mechanism 100 according to the embodiments of the present disclosure possesses the above technical effect, the battery production device according to the embodiments of the present disclosure thus also possesses corresponding technical effects. That is to say, it is possible to avoid the production of the metallic foreign matters during subsequent flattening processes, which helps improve the welding quality between the collector plate and the tab, while utilizing negative pressure to draw in the metallic foreign matters produced by cutting during slotting to remove dust, thereby avoiding impacts on the quality of the cell 400.

According to some other embodiments of the present disclosure, the battery production device is provided with a slotting station “a” where the slotting mechanism 100 is provided, as well as a jig 200 and a conveying mechanism. The jig 200 is configured to hold the cell 400. The conveying mechanism is configured to convey the jig 200 to the slotting station “a”, and a plurality of slotting mechanisms 100 are provided on both sides of the conveying mechanism.

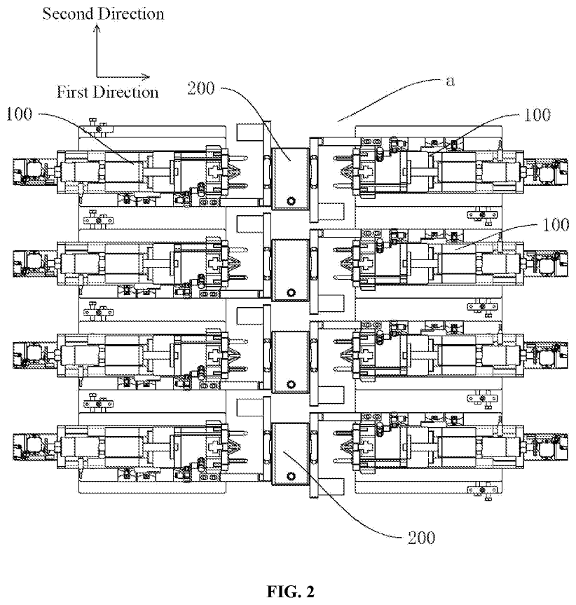

As shown in FIG. 2, the plurality of slotting mechanisms 100 may be provided on either side of the conveying mechanism respectively, and these slotting mechanisms 100 may be arranged in sequence along the conveying direction of the conveying mechanism, allowing simultaneous slotting at both ends of the cell 400. Through cooperation between the conveying mechanism, the jig 200, and the slotting mechanism 100, it is possible to achieve automated slotting, which is conducive to improving production efficiency.

Below is a detailed description of the slotting process for the cell 400 in the present embodiment.

The conveying mechanism conveys the jig 200, which is mounted with the cell 400, to the slotting station “a”. Then, the positioning pins 51 of the slotting mechanism 100 is inserted into the positioning holes 201 on the jig 200, completing the positioning of the jig 200. Pre-regulating the slotting pressure through the pressure regulating assembly ensures uniform pressing force on the end face. The second driving member 70 drives the slotting assembly 20 to approach the cell 400, so that the slotting cutter 22 can act on the end face of the cell 400. The pneumatic gripper cylinder, which functions as the first driving member 23, opens and causes the slotting cutter 22 to move outward along the radial direction of the cell 400. A pressure regulating valve can be employed to adjust the slotting force and speed. Debris produced during slotting enters the dust collection chamber 311 through the inlet 312, and is collected and removed under negative pressure through the outlet 313 and the dust collection channel 321.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. A slotting mechanism, comprising:
a base; and
a slotting assembly movably engaged with the base along a first direction to provide for moving towards or away from a cell and including slots positioned radially on an end face of the cell.

2. The slotting mechanism according to claim 1, wherein the slotting assembly comprises:
a mounting disk movably engaged with the base along the first direction;
a slotting cutter movably engaged with the mounting disk along a radial direction of the cell; and
a first driving member connected to the slotting cutter and configured to drive the slotting cutter.

3. The slotting mechanism according to claim 2, wherein a plurality of slotting cutters are positioned circumferentially around the mounting disk.

4. The slotting mechanism according to claim 2, wherein the slotting cutter comprises:
a connecting block connected to the mounting disk; and
a cutter head, a first end of which being connected to the connecting block and a second end being formed into a cutting edge, a distance between the cutter head and a side of the mounting disk facing the cutter head gradually increasing in a direction from periphery towards center of the mounting disk.

5. The slotting mechanism according to claim 4, wherein the cutting edge extends along a straight line, and is provided with a rounded termination at each of two ends thereof.

6. The slotting mechanism according to claim 2, wherein the slotting assembly further comprises:
a speed regulating valve provided on the first driving member for regulating a speed of the slotting cutter.

7. The slotting mechanism according to claim 1, further comprising:
a pressure regulating assembly connected to the slotting assembly for regulating a pressure between the slotting assembly and the end face of the cell.

8. The slotting mechanism according to claim 1, further comprising:
a dust collection assembly provided on the base, comprising a dust collection chamber and an inlet in communication with the dust collection chamber, the inlet configured for generating negative pressure to draw foreign matter produced during slotting into the dust collection chamber.

9. The slotting mechanism according to claim 8, wherein the slotting assembly is switchable between a first state and a second state;
in the first state, the slotting assembly is in contact with the end face of the cell and configured to provide slots positioned radially on the end face of the cell, and at least part of an orthogonal projection of the slotting assembly onto a horizontal plane is configured to overlap with an orthogonal projection of the inlet onto the horizontal plane;
in the second state, the slotting assembly is spaced apart from the cell, and the orthogonal projection of the slotting assembly onto the horizontal plane is configured to be offset with the orthogonal projection of the inlet onto the horizontal plane.

10. The slotting mechanism according to claim 8, wherein the dust collection assembly comprises:
a dust collection box provided with the dust collection chamber and provided with an inlet and an outlet, the inlet being located below the slotting assembly for collecting the foreign matter; and
a vacuuming member being in communication with the outlet for vacuuming the dust collection chamber.

11. The slotting mechanism according to claim 10, wherein the inlet and the outlet are spaced apart in a second direction perpendicular to the first direction.

12. The slotting mechanism according to claim 11, wherein the dust collection box and the inlet extend along the second direction respectively.

13. The slotting mechanism according to claim 11, wherein the dust collection chamber comprises a first channel, a second channel, and a third channel which are sequentially connected, the first channel and the second channel extending along a third direction respectively, the third channel extending along the second direction, the third direction being perpendicular to the first direction and the second direction respectively, one end of the first channel away from the second channel forming the inlet, a cross-sectional area of the first channel gradually decreasing in a direction from the first channel towards the second channel, and one end of the third channel away from the second channel forming an outlet.

14. The slotting mechanism according to claim 10, wherein the dust collection assembly further comprises:
a connection member provided on a side of the dust collection box away from the cell and provided with a dust collection channel inside extending along the first direction, a first end of the dust collection channel being in communication with the outlet, and a second end of the dust collection channel being in communication with the vacuuming member.

15. The slotting mechanism according to claim 1, further comprising:
a positioning assembly provided on the slotting assembly and configured to position a jig of the cell.

16. The slotting mechanism according to claim 15, wherein the positioning assembly comprises:
at least two positioning pins configured to cooperate with positioning holes on the jig to position the jig.

17. The slotting mechanism according to claim 1, further comprising:
a guiding member provided on the base and extending along the first direction, and the slotting assembly connected to and movable along the guiding member; and
a second driving member provided on the base and connected to the slotting assembly to drive it to move along the first direction.

18. A battery production device, comprising:
at least a slotting mechanism according to claim 1.

19. The battery production device according to claim 18, wherein the battery production device is provided with a slotting station where the slotting mechanism is provided, and further comprises:
a jig configured to hold the cell; and
a conveying mechanism configured to convey the jig to the slotting station, a plurality of slotting mechanisms provided on a first side and a second side of the conveying mechanism.
